(19) United States
(12) Patent Application Publication
(10) Pub. No.: US 2006/0129478 A1
(43) Pub. Date: Jun. 15, 2006

(54) Automated Short Term Loans

(75) Inventor: Kenneth E. Rees, Dallas, TX (US)

Correspondence Address: FISH & RICHARDSON P.C., P.O. BOX 1022, MINNEAPOLIS, MN, 55440-1022, US

(73) Assignee: PayDay One XL, LLC, Dallas, TX (US)

(21) Appl. No.: 11/275,121

(22) Filed: Dec. 12, 2005

Related U.S. Application Data
(60) Provisional application No. 60/634,538, filed on Dec. 10, 2004.

(51) Int. Cl. G06Q 40/00

(52) U.S. Cl. 705/38

(57) ABSTRACT

Automated techniques for providing loans, such as short term loans, include receiving a telephonic loan application from a customer and electronically verifying information in the telephonic loan application. Based on the results of the verification, a determination is made as to whether to provide the loan. When the loan is to be provided, the customer is instructed to accept the terms and conditions of the loan using a telephone. Upon acceptance, the loan is dispensed.

### CROSS REFERENCE TO RELATED APPLICATION

This application claims priority to U.S. Provisional Application No. 60/634,538, filed Dec. 10, 2004, which is incorporated by reference.

### TECHNICAL FIELD

This document relates to the automated provision of short-term loans using a telephone.

### BACKGROUND

Short-term, unsecured loans are known as payday loans. Payday loans are primarily for consumers who need relatively small amounts (e.g., less than $1000) for emergencies, and typically are repaid from the proceeds of the borrower's next paycheck.

The majority of payday loans are provided through physical stores, typically in areas with a high density of lower income borrowers. These stores are often not safe and have limited hours of operation. Furthermore, because of the high cost of establishing and staffing these stores, many geographic areas and towns cannot economically support these stores. This situation creates an inconvenient (and in some cases unsafe) experience for consumers who wish to receive short term loans.

Recently, payday loans have become available over the Internet. This has increased the convenience and privacy of payday lending transactions and allows anyone with a computer and access to the Internet the ability to quickly and conveniently apply for and receive payday loans.

### SUMMARY

Loans, such as short term loans, may be provided using automated, telephone-based techniques. The techniques include receiving a telephonic loan application from a customer and verifying information in the telephonic loan application. Based on the results of the verification, a determination is made as to whether to provide the loan. When the loan is to be provided, the customer is instructed to accept the terms and conditions of the loan using a telephone. Upon acceptance, the loan is dispensed.

Implementations may include one or more of the following features. For example, receiving the telephonic loan application may include having the customer provide information about the loan to one or both of a call center operator or an automated voice-response unit. The application information may also be provided using a communication method other than audio, such as one or more of a text message or a SMS message.

Verifying information in the telephonic loan application may include doing so automatically using an electronic database, such as by accessing databases of commercial information sources. Verifying information in the loan application also may include using information that was received from the customer prior to receipt of the telephonic loan application.

Instructing the customer to accept the terms and conditions of the loan using a telephone may include having the customer do so using an automated voice-response unit. Receiving the telephonic loan application from a customer may include having the customer providing information by spoken voice.

Determining whether to provide the loan comprises granting the loan when a sufficient amount of information in the loan application (e.g., all information) is verified. A loan for an amount less than an amount requested in the loan application may be provided based on employment or banking information provided in the loan application.

The customer may be permitted to contact a human representative, such as when the customer's loan has been declined or provided for an amount less than an amount requested in the loan application.

Dispensing the loan may include using an automated clearinghouse to dispense the loan to a bank account belonging to the customer. Dispensing the loan also may include using an ATM network to credit a bank account belonging to the customer by the loan amount. The described approaches may permit customers who do not have access to a computer or the Internet to apply for and receive payday loans without visiting a physical store. More particularly, these approaches allow customers to provide payday loan information and to be approved and funded through a phone call to a call center. In addition, these approaches may be used to provide a process and system that can be used by customers without requiring a stand-alone physical location, and providing a process and system that can be cost-effectively operated 24 hours a day, 7 days a week. In addition, relative to payday lending solutions that required the customer to fax application data and signed loan documents, these approaches may be used to provide a process that is faster and more convenient for customers, at can be used by customers without requiring access to a fax machine, and that has a very low cost of delivery.

Other features and advantages will be apparent from the following description, including the drawings, and the claims.

### DRAWING DESCRIPTION

FIG. 1. is a block diagram of a system for providing payday loans using a call center and a call center agent.

FIG. 2. is a block diagram of a system for providing payday loans without using a call center agent.

FIG. 3 is a flow chart of a process implemented by the system of FIG. 1.

FIG. 4 is a flow chart of a procedure implemented by the system of FIG. 1.

Like reference numbers and designations in the various drawings indicate like elements.

### DESCRIPTION

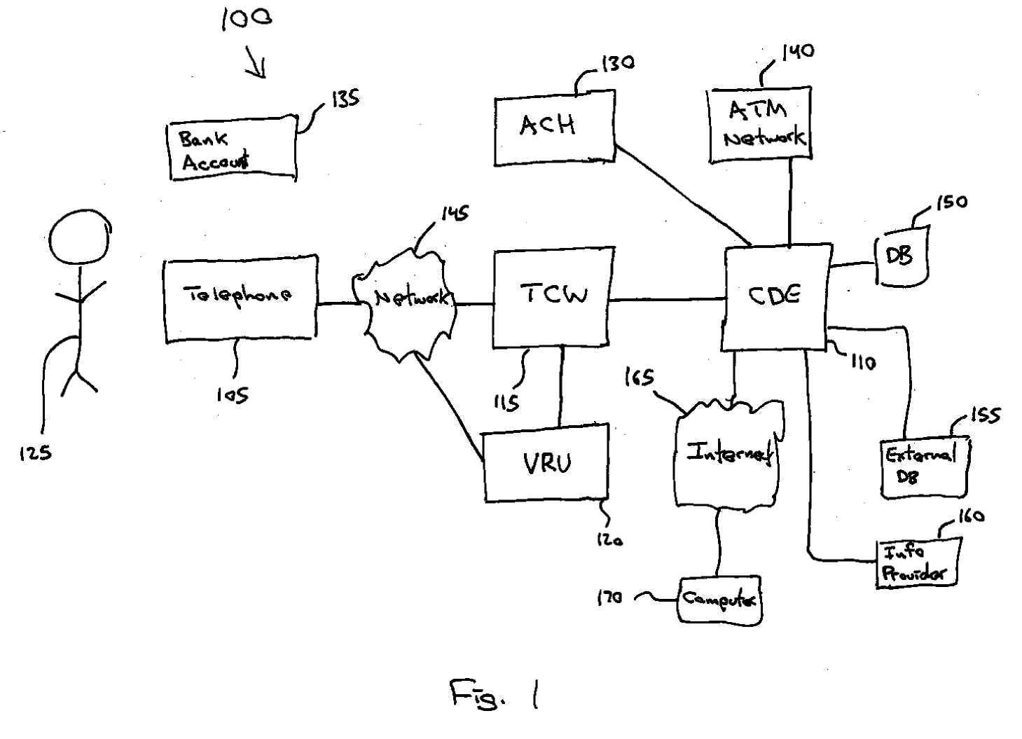

Referring to FIG. 1, a system 100 for providing automated short term loans uses a telephone 105, a central server (referred to as the Central Decision Engine, or CDE) 110, call center software (referred to as a Transaction Center Workstation, or TCW) 115, and a voice response unit (referred to as a VRU) 120 to initiate and fulfill the payday loan.

Using the system of FIG. 1, a payday loan is initiated by a customer 125 using the telephone 105. A customer service agent in a call center uses the TCW 115 to authenticate the customer and input transaction information. Based on this authentication and transaction information, the CDE 110 approves or declines the loan. Upon approval, the loan is accepted by the customer using the VRU 120, and is fulfilled through a message from the CDE 110 to an automated clearing house (ACH) 130 that causes the ACH to deposit the loan proceeds in the customer's bank account 135, or through a message to an ATM (automated teller machine) network 140.

The telephone 105 is a wired or wireless telephone with a numerical keypad. The telephone is connected to the TCW 115 through a telephone network 145 that may include one or more wired or wireless connections, including, for example, dial-up, frame-relay, ISDN, or DSL.

The CDE 110 includes software located on a computer processor with data storage capability. The CDE 110 processes incoming transaction requests and data from the TCW 115, and provides a flexible application for providing financial services.

Upon receiving a message from the TCW 115, the CDE 110 parses fields of the message, which may include, for example, customer name, address and requested loan amount, and uses pre-defined rules and internal and external databases 150 and 155 to determine whether to approve or decline the transaction. The CDE 110 takes into consideration past customer credit history and various other risk factors, which may be provided by external information providers 160 to make the decision. As shown, the CDE uses secured telephone lines to communicate with the ACH 130, the ATM network 140, the external databases 155 and the one or more third party information sources 160. In other implementations, the computer 115 may use the Internet 165 to communicate with one or more of the ACH 130, the ATM network 140, the databases 155 and the information sources 160.

The CDE may also use information provided by a customer prior to a loan request to streamline or simplify the loan application process. For example, a regular customer may define a personal profile, or may have an established history, that results in automatic approval of loans under certain conditions. Upon determining whether to approve or decline the loan request, the CDE transmits an appropriate message back to the TCW 115.

The VRU 120 may be programmed to communicate with a customer so as to provide and receive instructions and information verbally and to accept customer data input through the customer's phone keypad. This information is translated into a form that can be transmitted to the TCW 115 and the CDE 110 for additional processing and storage. The VRU 120 may also be programmed to provide or accept instructions in formats other than audio. For example, the VRU 120 may use text messages or SMS messages to provide notice of loan approval to a customer. As cell phones replace traditional “land-line” phones as primary telephones for people of all socioeconomic levels, the utilization of additional features such as displaying and receiving text will simplify the loan application process for more individuals.

As noted above, the loan may be processed and fulfilled through an ACH deposit to the customer's bank account 135. The loan also may be fulfilled through the ATM network 140.

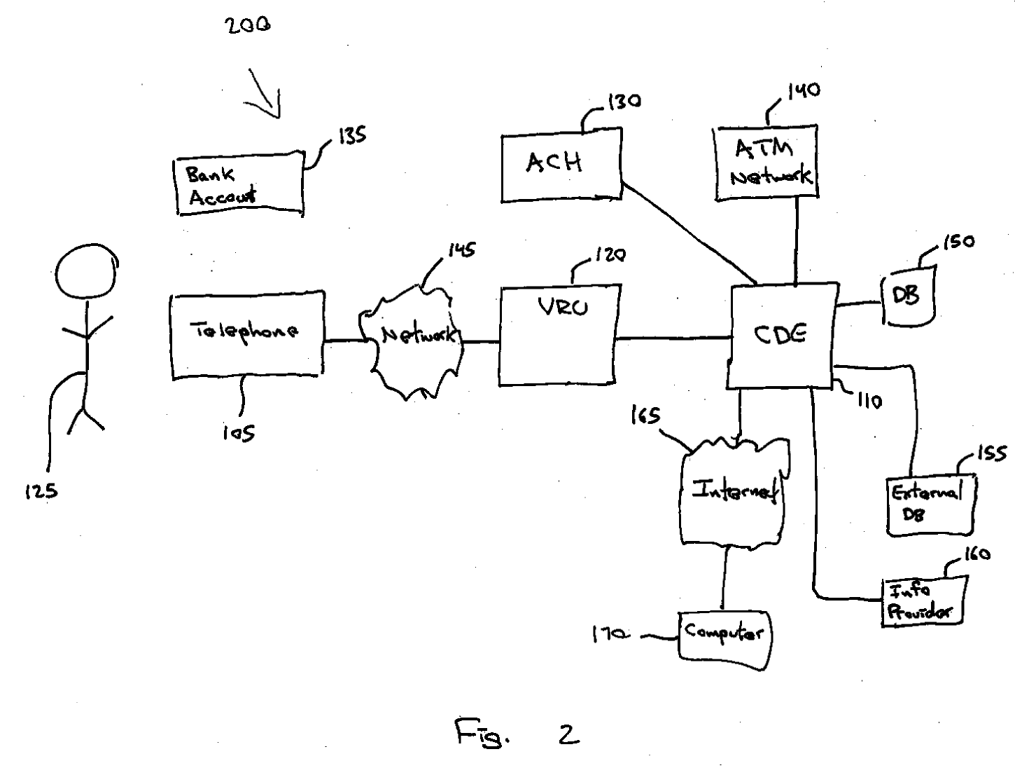

FIG. 2 illustrates an alternative implementation 200 in which the TCW is eliminated and the customer's phone 105 directly accesses the VRU 120, which communicates with the CDE without intervention by a customer service agent or a TCW. This eliminates the requirement for the customer service agent to enter the customer information.

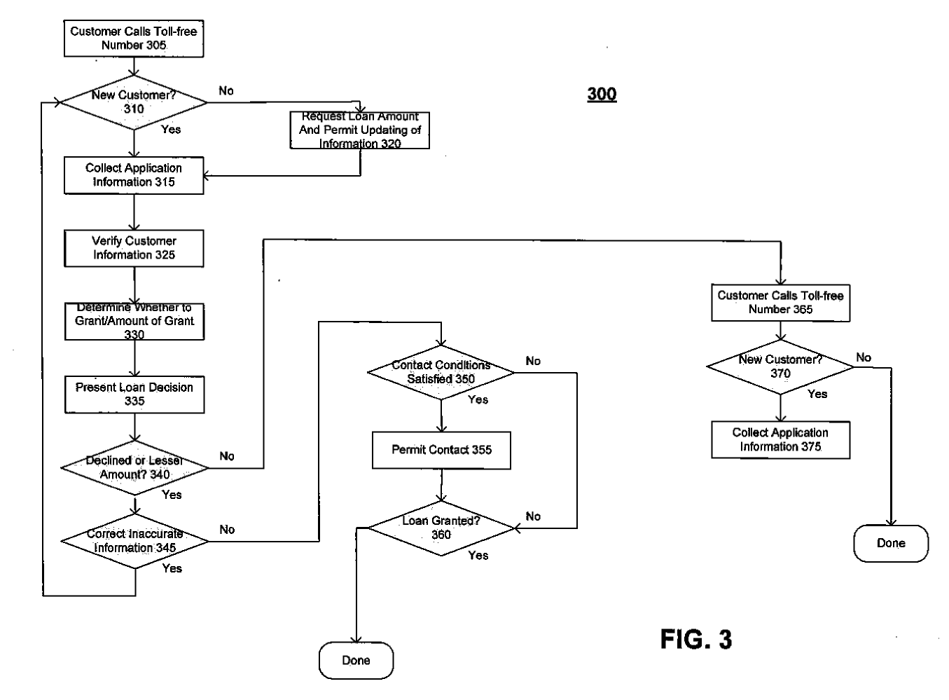

FIG. 3 illustrates a process 300 that may be implemented by the system of FIG. 1. The process demonstrates how a customer may apply for and receive a loan using a telephone. Initially, a customer calls a toll-free number to request a loan (305). An agent or the VRU then prompts the customer for information and determines whether the customer is a new customer or a returning customer (310).

If the customer is a new customer, the agent using the TCW or the VRU collects application information from the customer (315). In one implementation, the customer is asked to provide the following key points of information: name; address and years at address; previous address if at current address for less than two years; phone number; social security number; driver's license number; date of birth; place of birth; current employer; time at current employer; gross and net of last paycheck; references with phone numbers; routing and account number for bank account; name of bank; how long account has been open; amount and check number of last check written; credit card; billing address of credit card if different than home address; check card for same day finding; and desired loan amount. Other implementations may request only a subset of this information, or may request other information.

If the customer is a returning customer, the agent or the VRU asks the customer to indicate a desired loan amount (320). The agent or the VRU also may permit the customer to updated any information that has been provided previously.

Next, the customer's information is provided to and verified by the CDE 110 (325). Typically, the CDE 110 performs the verification by accessing internal or external databases 150 and 155 and/or one or more third-party, commercial information sources 160. For new customers, the CDE 110 verifies all of the information provided by the customer. By contrast, for existing customers, the CDE 110 only verifies information that is likely to have changed, such as, for example, the customer's address.

Next, using the information provided by the customer and the results of the verification, the CDE 110 determines whether to grant a loan and, when granting a loan, whether to permit the fill amount requested or a lesser amount (330). In general, the CDE will grant a loan when the customer has provided a sufficient amount of information and the CDE is able to verify most or all of the information provided by the customer. For example, the CDE might grant a loan when the CDE is able to verify all of the customer's information except the customer's previous address. The CDE will limit the amount of the loan based on the customer's employment and banking information.

The CDE may apply different standards depending upon whether the customer is a first time customer or one with an established payment history. For example, the CDE may require a loan granted to a first time customer to be for less than 15% of the customer's net pay, while permitting a loan granted to an established customer to be for as much as 25% of the customer's net pay.

Next the agent or the VRU presents the loan decision, as well as loan specifics, such as the amount and the interest rate, to the customer (335). When the CDE has decided to decline a loan, or has decided to grant a loan for less than the requested amount, the CDE may provide the customer with a list of the reasons for the CDE's decision, and may permit the customer to correct any inaccurate information that caused the decision.

If a customer who has been declined or granted a lesser amount (340) asks to correct inaccurate information (345), the agent or the VRU collects application information (315) and proceeds as discussed above.

When certain conditions are satisfied (350), the customer may be permitted to contact an agent using the TCW 115 (355). For example, a customer may be permitted to contact an agent when the customer's loan has been declined or has been granted for an amount less than the amount requested the customer has attempted to correct inaccurate information, and an agent is available. In one implementation, contact with a human representative is provided through a telephone conversation.

If a loan is granted after correcting inaccurate information or contacting a human representative (360), or if the loan was originally granted for the full amount (340), the CDE asks the customer to accept the terms and conditions of the loan by voice or using the telephone keypad (365). (Final loan documents are provided to the customer by, for example, mailing the loan documents.) Finally, once the customer accepts the loan (370), the CDE dispenses the loan (375).

The CDE may dispense the loan in a number of ways. For example, the CDE may use the currently common approach of using an ACH to dispense the loan to the customer's bank account for next day finding. The ACH transaction is, in effect, depositing an electronic check from the CDE to the customer's bank account, and may also be used to collect payments from the customer. Another approach is to credit the customer's bank account through the ATM network when the customer uses a check card for same day finding.

The CDE also may issue ATM cards to highly rated customers to permit such customers to obtain loan proceeds at any ATM in the world. The CDE may send such a card to a customer for future use with terms and conditions to be agreed to on the Internet with a digital signature. Once the terms are agreed upon, the CDE issues the customer a PIN and activates the card. As long as the customer is in good standing, the card is reusable like any ATM card, with or without requiring the customer to apply for an additional loan.

The standards applied in determining whether to grant or decline a loan, and the amount of the loan, may be automatically refined based on collections histories for loans provided. For example, if a percentage of the loans made that are not repaid is smaller than expected, this may indicate that the standards are too conservative and are granting too few loans, in which case the standards may be revised automatically to be less restrictive. Similar, but opposite, adjustments may be made when the percentage of unpaid loans is larger than expected. More refined adjustments may also be made. For example, unpaid loans may be analyzed to identify factors commonly associated with those loans, and these factors may be given special consideration when granting new loans.

Other implementations are within the scope of the following claims. For example, referring again to FIGS. 1 and 2, in certain implementations, the CDE 110 also may use the connection to the Internet 165 to process other loan applications that are provided through a computer 170 connected to the Internet. In yet other implementations, the computer 170 may be replaced by a personal digital assistant, a wireless telephone, or another wireless or handheld device.

Both the computer 170 and the CDE 110 are connected to the Internet 165, and the two computers communicate with each other through this connection.

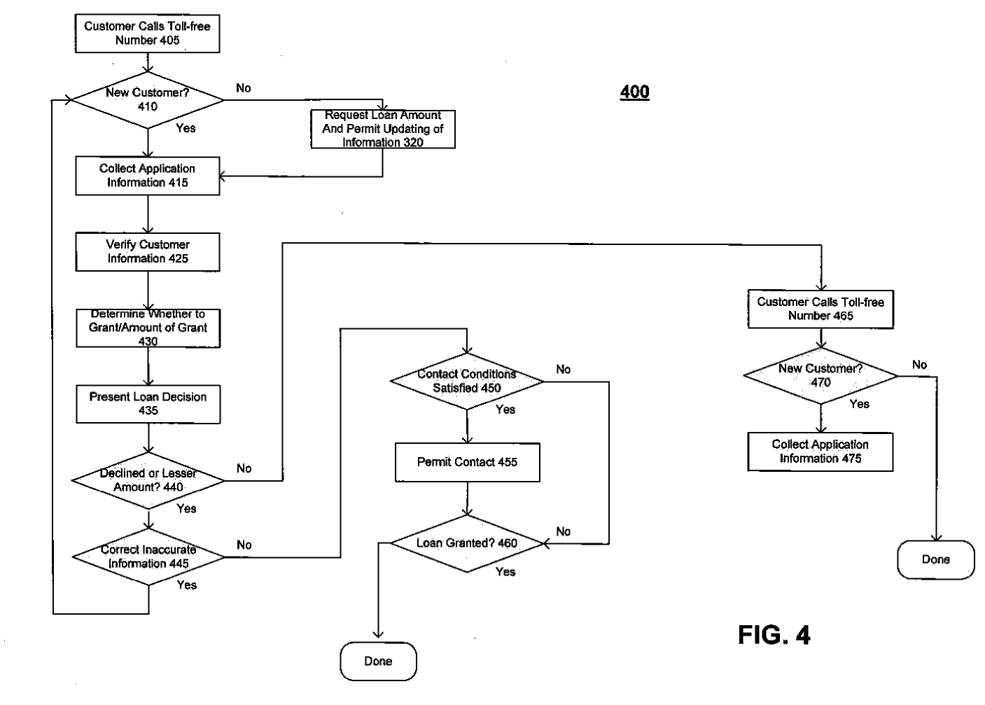

Referring to FIG. 4, for such Internet-based loans, the loan transaction, including the decision to approve or decline a loan, is performed entirely over the Internet with no physical collateral or documents being required for approval or denial of the loan The process for making the loan decision is fully automated, and proceeds according to a procedure 400. First, the customer accesses the CDE 110 using, for example, browser software (405). The CDE 110 then determines whether the customer is a new customer or a returning customer (410).

If the customer is a new customer, the CDE 110 presents the customer with an electronic application that the customer then fills out (415). In one implementation, the electronic application asks the customer to provide the following key points of information: name; address and years at address; previous address if at current address for less than two years; phone number; social security number; driver's license number; date of birth; place of birth; current employer; time at current employer; gross and net of last paycheck; references with phone numbers; routing and account number for bank account; name of bank; how long account has been open; amount and check number of last check written; credit card; billing address of credit card if different than home address; check card for same day finding; and desired loan amount. Other implementations may request only a subset of this information, or may request other information.

If the customer is a returning customer, the CDE 110 asks the customer to indicate a desired loan amount (420). The CDE 110 also may permit the customer to edit any of the information previously provided on the electronic application.

Next, the CDE 110 verifies the customer's information (425). Typically, the CDE 110 performs the verification by accessing internal or external databases 150 and 155 and/or one or more third-party, commercial information sources 160. For new customers, the CDE 110 verifies all of the information provided by the customer. By contrast, for existing customers, the CDE 110 only verifies information that is likely to have changed, such as, for example, the customer's address.

Next, using the information provided by the customer and the results of the verification, the CDE 110 determines whether to grant a loan and, when granting a loan, whether to permit the full amount requested or a lesser amount (430). In general, the CDE will grant a loan when the customer has provided a sufficient amount of information and the CDE is able to verify most or all of the information provided by the customer. For example, the CDE might grant a loan when the CDE is able to verify all of the customer's information except the customer's previous address. The CDE will limit the amount of the loan based on the customer's employment and banking information.

Next, the CDE presents the loan decision to the customer (435). When the CDE has decided to decline a loan, or has decided to grant a loan for less than the requested amount the CDE may provide the customer with a list of the reasons for the CDE's decision, and may permit the customer to correct any inaccurate information that caused the decision.

If a customer who has been declined or granted a lesser amount (440) asks to correct inaccurate information (445), the CDE presents the customer with the electronic application (415) and proceeds as discussed above.

When certain conditions are satisfied (450), the CDE may permit a customer to contact a human representative using the TCW 115 (455). For example, a customer may be permitted to contact a human representative when the customer's loan has been declined or has been granted for an amount less than the amount requested, and the customer has attempted to correct inaccurate information. In one implementation, contact with a human representative is provided through an instant messaging interface in which the customer and the CDE representative successively type their comments in real time.

If a loan is granted after correcting inaccurate information or contacting a human representative (460), or if the loan was originally granted for the full amount (440), the CDE asks the customer to accept the terns and conditions of the loan using a digital signature (465). Finally, once the customer accepts the loan (470), the CDE dispenses the loan (475).

What is claimed is:

1. A method for providing a loan using a telephone connection, the method comprising:
receiving a telephonic loan application from a customer;
verifying information in the telephonic loan application;
based on the results of the verification, determining whether to provide the loan;
instructing the customer to accept the terms and conditions of the loan using a telephone; and
dispensing the loan.

2. The method of claim 1, wherein receiving the telephonic loan application comprises having the customer provide information about the loan to a call center operator.

3. The method of claim 1, wherein receiving the telephonic loan application comprises having the customer provide information about the loan to an automated voice-response unit.

4. The method of claim 1, wherein verifying information in the telephonic loan application comprises doing so automatically using an electronic database.

5. The method of claim 1, wherein instructing the customer to accept the terms and conditions of the loan using a telephone comprises having the customer do so using an automated voice-response unit.

6. The method of claim 3, wherein receiving the telephonic loan application from a customer includes the customer providing information by spoken voice.

7. The method of claim 1, wherein verifying information in the telephonic loan application comprises using information that was received from the customer prior to receipt of the telephonic loan application.

8. The method of claim 1, wherein receiving the telephonic loan application comprises using a communication method other than audio.

9. The method of claim 8, wherein the communication method other than audio comprises using one or more of a text message or a SMS message.

10. The method of claim 1, wherein electronically verifying information in the loan application comprises accessing databases of commercial information sources.

11. The method of claim 1, wherein determining whether to provide the loan comprises granting the loan when a sufficient amount of information in the loan application is verified.

12. The method of claim 11 wherein the sufficient amount of information comprises all information in the loan application.

13. The method of claim 1 wherein determining whether to provide the loan further comprises providing a loan for an amount less than an amount requested in the loan application based on employment or banking information provided in the loan application.

14. The method of claim 1 further comprising permitting the customer to contact a human representative.

15. The method of claim 14, wherein permitting the customer to contact the human representative comprises doing so when the customer's loan has been declined.

16. The method of claim 14, wherein permitting the customer to contact the human representative comprises doing so when the customer's loan has been provided for an amount less than an amount requested in the loan application.

17. The method of claim 1, wherein dispensing the loan comprises using an automated clearinghouse to dispense the loan to a bank account belonging to the customer.

18. The method of claim 1, wherein dispensing the loan comprises using an ATM network to credit a bank account belonging to the customer by the loan amount.
